(19) United States
(12) Patent Application Publication
(10) Pub. No.: US 2026/0161170 A1
(43) Pub. Date: Jun. 11, 2026

(54) OBJECT TRACKING APPARATUS AND VEHICLE CONTROL APPARATUS

(71) Applicant: Honda Motor Co., Ltd., Tokyo (JP)

(72) Inventors: Daichi Saeki, Saitama (JP); Shunsuke Konishi, Saitama (JP); Zao shan Chong, Saitama (JP); Shuhei Masuoka, Utsunomiya-shi (JP)

(21) Appl. No.: 19/405,187

(22) Filed: Dec. 1, 2025

(30) Foreign Application Priority Data
Dec. 6, 2024 (JP) 2024-213406

(51) Int. Cl. G05D 1/633; G01S 17/66; G01S 17/931

(52) U.S. Cl. CPC G05D 1/633; G01S 17/66; G01S 17/931

(57) ABSTRACT

A object tracking apparatus stores moving point cloud data classified from point cloud data acquired by a LiDAR in a memory; offsets a position of each measurement point included in the moving point cloud data of past point cloud frames, based on a moving speed and direction of each measurement point; when the moving point cloud data is classified from newly acquired point cloud data, superimposes, onto the moving point cloud data, the offset moving point cloud data of past frames; detects the moving object based on the moving point cloud data after the superimposition; calculates a movement vector of the moving object based on a position of the measurement point cloud corresponding to the moving object in the past point cloud frames and the newly acquired point cloud frame; and obtains a movement path of the moving object based on the movement vector.

### CROSS-REFERENCE TO RELATED APPLICATION

This application is based upon and claims the benefit of priority from Japanese Patent Application No. 2024-213406 filed on Dec. 6, 2024, the content of which is incorporated herein by reference.

### BACKGROUND

### Technical Field

The present invention relates to an object tracking apparatus configured to detect and track an object in the surroundings of a vehicle and a vehicle control apparatus including the object tracking apparatus.

### Related Art

As this type of device, a device that detects and tracks a moving object using three-dimensional point cloud data that has been acquired by a LiDAR is known (for example, refer to Japanese Patent No. 7126633).

However, in a case where point cloud data is directly used for detection processing of the moving object as in the device disclosed in Japanese Patent No. 7126633, there is a possibility that detection of a distant moving object or a small-sized moving object may be delayed, and that the moving object may not be accurately tracked.

### SUMMARY

An aspect of the present invention is an object tracking apparatus including: a detector configured to acquire point cloud data including, for measurement points on a surface of an object included in a three-dimensional space, three-dimensional position information and speed information indicating a relative moving speed, by emitting electromagnetic waves into the three-dimensional space and receiving reflected waves, for each point cloud frame including the point cloud data at a same time point; an actuator for vehicle travel; a microprocessor; and a memory connected to the microprocessor. The microprocessor is configured to perform: calculating an absolute moving speed of each of a plurality of the measurement points corresponding to the point cloud data based on the speed information; classifying, when the point cloud data is acquired by the detector, the point cloud data into moving point cloud data in which an absolute value of the absolute moving speed is equal to or greater than a predetermined speed, and stationary point cloud data other than the moving point cloud data; storing the moving point cloud data classified in the classifying in the memory; executing object tracking processing of detecting a moving object moving in the three-dimensional space, calculating a movement vector of the moving object, and obtaining a movement path of the moving object based on the movement vector. In the object tracking processing, the microprocessor is configured to perform: executing offset processing of offsetting a position of each measurement point corresponding to past point cloud frames stored in the memory, based on a moving speed and a moving direction of each measurement point estimated based on the speed information of the measurement point; executing, when the moving point cloud data is classified from the point cloud data included in a new point cloud frame acquired by the detector, superimposition processing of superimposing the offset moving point cloud data of the past point cloud frames onto the moving point cloud data; and detecting the moving object based on the moving point cloud data after the superimposition processing. The microprocessor is configured to perform: the calculating of the movement vector including calculating the movement vector of the moving object based on a position of measurement point cloud corresponding to the moving object in the past point cloud frame and the new point cloud frame.

### BRIEF DESCRIPTION OF DRAWINGS

The objects, features, and advantages of the present invention will become clearer from the following description of embodiments in relation to the attached drawings, in which:

FIG. 1 is a block diagram illustrating a configuration of a substantial part of a vehicle control apparatus including an object tracking apparatus according to the embodiment of the present invention;

FIG. 2A is a diagram illustrating an example of a three-dimensional object included in a three-dimensional space around a subject vehicle;

FIG. 2B is a diagram illustrating a plan view of the moving object of FIG. 2A as viewed from above;

FIG. 3A is a diagram illustrating a situation in which a plurality of pedestrians are passing each other;

FIG. 3B is a diagram illustrating an example of XYV data;

FIG. 4A is a diagram illustrating an example of a three-dimensional space around the subject vehicle;

FIG. 4B is a diagram illustrating XYV data corresponding to the three-dimensional space in FIG. 4A;

FIG. 4C is a diagram illustrating XYV data corresponding to the three-dimensional space in FIG. 4A;

FIG. 5A is a diagram illustrating an example of measurement point clouds of a past frame superimposed on XYV data of a current frame without being subjected to offset processing;

FIG. 5B is a diagram illustrating an example of superimposed XYV data;

FIG. 6 is a diagram for describing detection of the moving object;

FIG. 7 is a diagram for describing calculation of a movement vector of the moving object; and

FIG. 8 is a flowchart illustrating an example of processing to be performed by of the controller in FIG. 1.

### DETAILED DESCRIPTION

Hereinafter, embodiments of the present invention will be described with reference to the drawings. An object tracking apparatus according to an embodiment of the present invention is applicable to a vehicle having a self-driving capability, that is, a self-driving vehicle. Note that a vehicle to which the object tracking apparatus according to the present embodiment is applied will be referred to as a subject vehicle to be distinguished from other vehicles, in some cases. The subject vehicle may be any of an engine vehicle having an internal combustion (engine) as a traveling drive source, an electric vehicle having a traveling motor as the traveling drive source, and a hybrid vehicle having an engine and a traveling motor as the traveling drive source. The subject vehicle is capable of traveling not only in a self-drive mode that does not necessitate the driver's driving operation but also in a manual drive mode of the driver's driving operation.

While a self-driving vehicle is moving in the self-drive mode (hereinafter, referred to as self-driving or autonomous driving), such a self-driving vehicle recognizes an exterior environment situation in the surroundings of the subject vehicle, based on detection data of an in-vehicle detector such as a light detection and ranging (LiDAR). The self-driving vehicle generates a driving path (a target path) at a predetermined time elapsed after the current time, based on a recognition result, and controls an actuator for driving so that the subject vehicle travels along the target path.

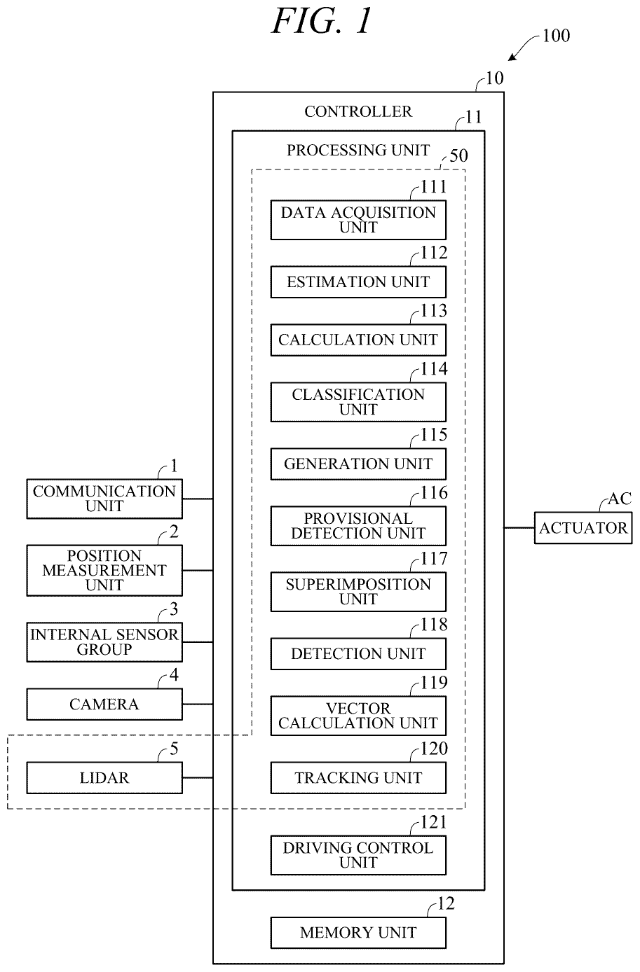

FIG. 1 is a block diagram illustrating a configuration of a substantial part of a vehicle control apparatus 100 including the object tracking apparatus. The vehicle control apparatus 100 includes a controller 10, a communication unit 1, a position measurement unit 2, an internal sensor group 3, a camera 4, a LiDAR 5, and a traveling actuator AC. In addition, the vehicle control apparatus 100 includes an object tracking apparatus 50, which constitutes a part of the vehicle control apparatus 100. The object tracking apparatus 50 detects an object in the surroundings of a vehicle, based on detection data of the LiDAR 5.

The communication unit 1 communicates with various servers, not illustrated, through a network including a wireless communication network represented by the Internet network, a mobile telephone network, or the like, and acquires map information, traveling history information, traffic information, and the like from the servers regularly or at a given timing. The network includes not only a public wireless communication network but also a closed communication network provided for every predetermined management area, for example, a wireless LAN, Wi-Fi (registered trademark), Bluetooth (registered trademark), and the like. The acquired map information is output to a memory unit 12, and the map information is updated. The position measurement unit (GNSS unit) 2 includes a position measurement sensor for receiving a position measurement signal transmitted from a position measurement satellite. The positioning satellite is an artificial satellite such as a GPS satellite or a quasi-zenith satellite. By using the position measurement information that has been received by the position measurement sensor, the position measurement unit 2 measures a current position (latitude, longitude, and altitude) of the subject vehicle.

The internal sensor group 3 is a generic term for a plurality of sensors (internal sensors) that detect a traveling state of the subject vehicle. For example, the internal sensor group 3 includes a vehicle speed sensor that detects the vehicle speed of the subject vehicle, an acceleration sensor that detects the acceleration in a front-rear direction and the acceleration (lateral acceleration) in a left-right direction of the subject vehicle, a rotation speed sensor that detects the rotation speed of the traveling drive source, a yaw rate sensor that detects the rotation angular speed around the vertical axis of the center of gravity of the subject vehicle, and the like. The internal sensor group 3 also includes sensors that detect a driver's driving operation in the manual drive mode, for example, an operation on an accelerator pedal, an operation on a brake pedal, an operation on a steering wheel, and the like.

The camera 4 includes an imaging element such as a CCD or a CMOS, and captures an image of the surroundings of the subject vehicle (a forward side, a rearward side, and lateral sides). The LiDAR 5 irradiates a three-dimensional space in the surroundings of the subject vehicle with an electromagnetic wave (a reflected wave), and detects an exterior environment situation in the surroundings of the subject vehicle, based on the reflected wave. More specifically, the electromagnetic wave (a laser beam or the like) that has been irradiated from the LiDAR 5 is reflected on and returned from a certain point (a measurement point) on the surface of an object, and thus the distance from the laser source to such a point, the intensity of the electromagnetic wave that has been reflected and returned, the relative speed of the object located at the measurement point, and the like are measured. The electromagnetic wave of the LiDAR 5, which is attached to a predetermined position (a front part) of the subject vehicle is scanned in a horizontal direction and a vertical direction with respect to the surroundings (a forward side) of the subject vehicle. Thus, the position, the shape, the relative moving speed, and the like of an object (a moving object such as another vehicle or a stationary object such as a road surface or a structure) on a forward side of the subject vehicle are detected. A target object detected by the LiDAR 5 will be referred to as an object including a person. Therefore, a moving object includes a moving person (a pedestrian or the like), in addition to a moving vehicle such as an automobile or a bicycle. Note that hereinafter, the above three-dimensional space will be represented by an X axis along an advancing direction of the subject vehicle, a Y axis along a vehicle width direction of the subject vehicle, and a Z axis along a height direction of the subject vehicle. Therefore, the above three-dimensional space will be referred to as an XYZ space, in some cases.

The actuator AC is a traveling actuator for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the actuators AC includes the traveling motor. The actuator AC also includes a brake actuator that operates a braking device of the subject vehicle and a steering actuator that drives the steering device.

The controller 10 includes an electronic control unit (ECU). More specifically, the controller 10 is configured to include a computer including a processing unit 11 such as a CPU (microprocessor), the memory unit 12 such as a ROM and a RAM, and other peripheral circuits (not illustrated) such as an I/O interface. Note that a plurality of ECUs having different functions such as an engine control ECU, a traveling motor control ECU, and a braking device ECU can be separately provided, but in FIG. 1, the controller 10 is illustrated as an aggregation of these ECUs as a matter of convenience.

The memory unit 12 stores highly precise detailed map information (referred to as high-precision map information). The high-precision map information includes position information of roads, information of road shapes (curvatures or the like), information of road gradients, position information of intersections and branch points, information of the number of traffic lanes (traveling lanes), information of traffic lane widths and position information for every traffic lane (information of center positions of traffic lanes or boundary lines of traffic lane positions), position information of landmarks (traffic lights, traffic signs, buildings, and the like) as marks on a map, and information of road surface profiles such as irregularities of road surfaces. In addition, the memory unit 12 stores programs for various types of control, information such as a threshold for use in a program, and setting information for the in-vehicle detection unit such as the LiDAR 5.

The processing unit 11 includes, as a functional configuration, a data acquisition unit 111, an estimation unit 112, a calculation unit 113, a classification unit 114, a generation unit 115, a provisional detection unit 116, a superimposition unit 117, a detection unit 118, a vector calculation unit 119, a tracking unit 120, and a driving control unit 121.

As illustrated in FIG. 1, the data acquisition unit 111, the estimation unit 112, the calculation unit 113, the classification unit 114, the generation unit 115, the provisional detection unit 116, the superimposition unit 117, the detection unit 118, the vector calculation unit 119 and the tracking unit 120 are included in the object tracking apparatus 50. Details of the data acquisition unit 111, the estimation unit 112, the calculation unit 113, the classification unit 114, the generation unit 115, the provisional detection unit 116, the superimposition unit 117, the detection unit 118, the vector calculation unit 119 and the tracking unit 120 will be described later.

In the self-drive mode, the driving control unit 121 generates a target path on the basis of an external environment situation around the vehicle, which includes the size, position, and relative moving speed of an object detected by the detection unit 118, a movement path of the object obtained by the tracking unit 120, and the like. Specifically, the driving control unit 121 generates the target path to avoid collision or contact with the object or to follow the object. The driving control unit 121 controls the actuator AC such that the subject vehicle travels along the target path. Specifically, the driving control unit 121 controls the actuator AC along the target path to adjust an accelerator opening or to drive the braking device or the steering device. Note that in the manual drive mode, the driving control unit 121 controls the actuator AC in accordance with a driving command (a steering operation or the like) from the driver that has been acquired by the internal sensor group 3.

Details of the object tracking apparatus 50 will be described. As described above, the object tracking apparatus 50 includes the data acquisition unit 111, the estimation unit 112, the calculation unit 113, the classification unit 114, the generation unit 115, the provisional detection unit 116, the superimposition unit 117, the detection unit 118, the vector calculation unit 119 and the tracking unit 120. The object tracking apparatus 50 further includes the LiDAR 5.

The data acquisition unit 111 acquires, as detection data of the LiDAR 5, four-dimensional data (hereinafter, referred to as point cloud data) which includes position information indicating three-dimensional position coordinates of a measurement point on a surface of the object from which the reflected wave of the LiDAR 5 is obtained, and speed information indicating the relative moving speed of the measurement point. The point cloud data is acquired by the LiDAR 5 on a frame-by-frame basis, specifically, at a predetermined time interval (a time interval determined by a frame rate of the LiDAR 5).

The estimation unit 112 estimates an absolute moving speed of the subject vehicle, on the basis of the point cloud data that has been acquired by the data acquisition unit 111. Here, estimation of the absolute moving speed of the subject vehicle by the estimation unit 112 will be described.

First, the estimation unit 112 extracts point cloud data obtained by removing information of measurement points corresponding to a three-dimensional object from the point cloud data that has been acquired by the data acquisition unit 111, that is, point cloud data (hereinafter, referred to as road surface point cloud data) corresponding to a road surface around the subject vehicle. The estimation unit 112 calculates, in accordance with the following Formula (i), a unit vector ei indicating a direction of a relative moving speed vi, on the basis of position coordinates (xi, yi, zi) included in the road surface point cloud data, that is, in four-dimensional data (xi, yi, zi, vi) of measurement point Pi (i=1, 2, . . . , n) corresponding to the road surface.

$${e}_{i} = \frac{( {x}_{i} , {y}_{i} , {z}_{i} )}{‖ {x}_{i} , {y}_{i} , {z}_{i} ‖} = ( {x}_{ei} , {y}_{ei} , {z}_{ei} ) \qquad Formula ( i )$$

Next, the estimation unit 112 estimates a movement vector (moving speed (absolute moving speed) and moving direction) Vself of the subject vehicle. Specifically, the estimation unit 112 sets, as an objective function L, a conversion formula for converting the relative moving speed vi of the measurement point Pi corresponding to the road surface into the absolute moving speed, and solves an optimization problem that optimizes the objective function L so as to approach zero. Since the measurement point Pi is the measurement point on the road surface, absolute speed of each measurement point should be zero. Therefore, by optimizing the objective function L so as to approach zero, a correct Vself can be estimated. Vself is expressed by speed components in XYZ-axis directions as indicated in the following Formula (ii). The objective function L is expressed by the following Formula (iii). By solving the above optimization problem, Vself that makes the right side of Formula (iii) zero is searched for. Note that zero may be set to Vself as an initial value, or Vself that has been estimated in a previous frame may be set. In addition, a measurement point estimated to have an absolute speed of zero may be extracted by another method, and the extracted measurement point may be used as the measurement point Pi.

$${V}_{self} = ( {v}_{x} , {v}_{y} , {v}_{z} ) \qquad Formula ( ii )$$

$$L ( V , f ( A , {V}_{self} ) ) = V + A \cdot {{V}_{self}}^{T} \qquad Formula ( iii )$$

In Formula (iii), A represents a matrix of unit vectors ei of n measurement points corresponding to the road surface, and is expressed by Formula (iv). In addition, in Formula (iii), V represents a 1×n matrix indicating speed components (relative moving speeds) of the n measurement points Pi corresponding to the road surface, and is expressed by Formula (v). The estimation unit 112 acquires Vself obtained by solving the above optimization problem, as an estimated value of the absolute moving speed of the subject vehicle in a current frame.

$$A = {[ {e}_{1} , {e}_{2} , … , {e}_{n} ]}^{T} = [ \begin{matrix}{x}_{e 1} & {y}_{e 1} & {z}_{e 1} \\ {x}_{e 2} & {y}_{e 2} & {z}_{e 2} \\ ⋮ & ⋮ & ⋮ \\ {x}_{en} & {y}_{en} & {z}_{en}\end{matrix} ] \qquad Formula ( iv )$$

$$V = {[ {v}_{1} , {v}_{2} , … , {v}_{n} ]}^{T} \qquad Formula ( v )$$

The calculation unit 113 calculates the absolute moving speeds of all measurement points, more specifically, all measurement points including the measurement points corresponding to the three-dimensional object, on the basis of the movement vector Vself of the subject vehicle, which has been estimated by the estimation unit 112. Here, the calculated absolute moving speed of the measurement point takes a negative value in a case where the measurement point approaches the subject vehicle, and takes a positive value in a case where the measurement point moves away from the subject vehicle.

The classification unit 114 classifies the point cloud data that has been acquired by the data acquisition unit 111, into moving point cloud data corresponding to the measurement point of which the absolute value of the absolute moving speed that has been calculated by the calculation unit 113 is equal to or greater than a predetermined speed Th #V and stationary point cloud data corresponding to the measurement point of which the absolute value is less than the predetermined speed Th #V.

The generation unit 115 generates speed-added data by adding the absolute moving speed calculated by the calculation unit 113 to the moving point cloud data. More specifically, the generation unit 115 adds the absolute moving speed corresponding to each of the measurement points, to each piece of position information of the measurement points included in the moving point cloud data. The generation unit 115 stores the generated speed-added data in the memory unit 12 together with a frame ID of the current frame.

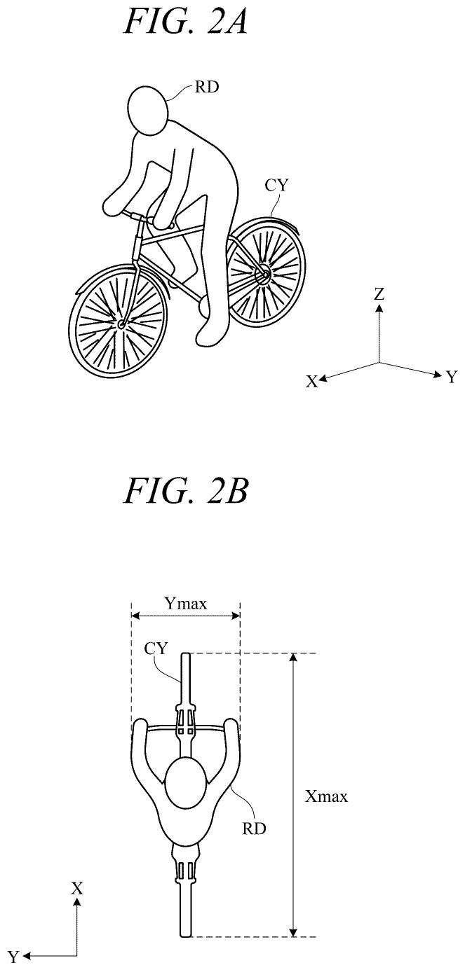

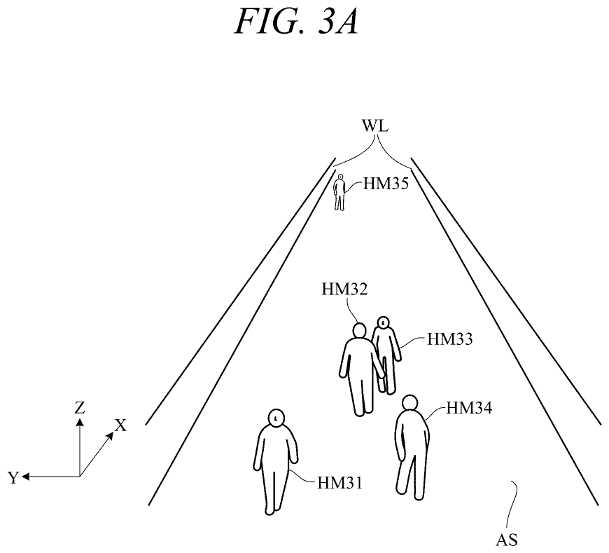

FIGS. 2A and 2B are diagrams illustrating an example of a three-dimensional object included in a three-dimensional space around the subject vehicle. FIG. 2A illustrates a moving object (a bicycle CY and a person RD riding the bicycle CY) traveling in front of the subject vehicle in a traveling direction (X direction) of the subject vehicle. FIG. 2B illustrates a plan view of the moving object of FIG. 2A as viewed from above (Z direction). As illustrated in FIG. 2B, maximum sizes (Xmax and Ymax) of the three-dimensional object in the XY directions can be recognized even without information in the height direction (Z direction) of the three-dimensional object.

Then, the generation unit 115 may project each of the measurement points onto a plane so as to remove information in the height direction from the position information of the measurement points corresponding to the moving point cloud data, and convert the position information of the measurement points from three-dimensional data into two-dimensional data. Specifically, in a case where position coordinates of the measurement points are represented in an XYZ coordinate system, the generation unit 115 may project the measurement points corresponding to the moving point cloud data onto an XY plane, and convert the moving point cloud data into two-dimensional data (XY data) represented in an XY coordinate system. In this case, the generation unit 115 generates three-dimensional speed-added data (XYV data) obtained by adding the absolute moving speed to the XY data. Hereinafter, a case where the speed-added data generated by the generation unit 115 is XYV data will be described as an example.

The provisional detection unit 116 detects the moving object around the subject vehicle on the basis of the XYV data that has been generated by the generation unit 115. More specifically, the provisional detection unit 116 executes clustering processing on the XYV data, and detects a bounding box, which is a circumscribed region of the moving object, from the XY plane.

Meanwhile, because an object that is distant from the subject vehicle or an object having a small size has a smaller number of point clouds (smaller number of measurement points) measured by the LiDAR, such an object may fail to be detected or may be detected with delay in the clustering processing. Therefore, in order to suppress such detection omission and detection delay, the provisional detection unit 116 executes clustering processing by lowering a threshold value for the number of measurement points regarded as a point cloud. In the clustering processing performed by the provisional detection unit 116 (hereinafter, referred to as provisional clustering processing), a smaller value Th0 than a threshold value Th1 of the clustering processing performed by the detection unit 118, which will be described later, is set as the threshold value.

Hereinafter, detection of the moving object by the provisional detection unit 116 may be referred to as provisional detection of the moving object. Note that any method such as Density-Based Spatial Clustering of Applications with Noise (DBSCAN) or a K-means method may be used for clustering processing executed by the provisional detection unit 116 and the detection unit 118.

The provisional detection unit 116 detects a position and a size of the moving object on the XY plane on the basis of a position and a size of the bounding box region (circumscribed region) detected through the provisional clustering processing. The provisional detection unit 116 stores, in the memory unit 12, information that allows identification of the measurement point cloud corresponding to the detected moving object, that is, the measurement point cloud included in the detected bounding box, as a provisional detection result.

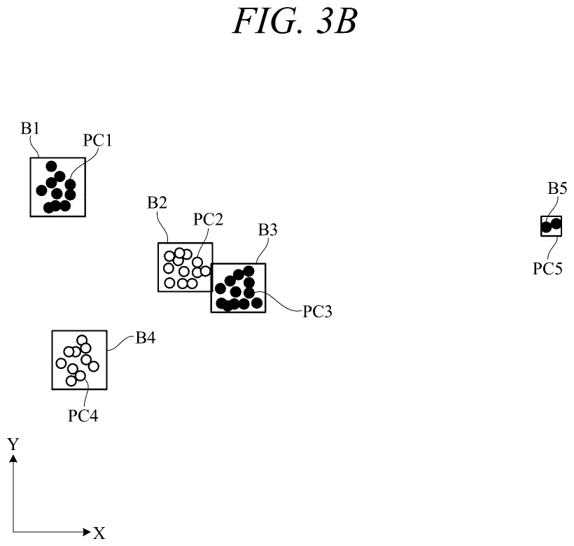

Here, provisional detection of the moving object by the provisional detection unit 116 will be described. FIG. 3A is a diagram illustrating a situation in which a plurality of pedestrians are passing each other. In this example, detection data of the LiDAR installed in a concourse AS in FIG. 3A, rather than detection data of the LiDAR mounted on the vehicle, is used. FIG. 3A illustrates the concourse AS as viewed from a viewpoint of the LiDAR. FIG. 3A illustrates a situation in which pedestrians HM32 and HM34 are moving (walking) in the same direction (X-axis direction) along an extending direction of the concourse AS, and pedestrians HM31, HM33, and HM35 are moving (walking) in the opposite direction. The absolute values of the absolute moving speeds of the pedestrians HM31 to HM35 are equal to or greater than the predetermined speed Th #V.

FIG. 3B is a diagram illustrating an example of three-dimensional data (XYV data) generated by the generation unit 115. FIG. 3B illustrates XYV data obtained by adding the absolute moving speeds of the pedestrians HM31 to HM35 to the two-dimensional data obtained by projecting, onto an XY plane, measurement point clouds (clusters) PC1 to PC5 corresponding to the pedestrians HM31 to HM35 in FIG. 3A. In FIG. 3B, the measurement point cloud of each pedestrian is drawn in a color in accordance with the absolute moving speed of each pedestrian. For simplification of description, it is assumed that the absolute moving speeds of the pedestrians HM31, HM33, and HM35 are equal to one another. It is assumed that the absolute moving speeds of the pedestrians HM32 and HM34 are also equal to each other. Therefore, in FIG. 3B, the measurement point clouds PC1, PC3, and PC5 corresponding to the pedestrians HM31, HM33, and HM35 are drawn in the same color (black), and the measurement point clouds PC2 and PC4 corresponding to the pedestrians HM32 and HM34 are drawn in a different color (white).

In addition, FIG. 3B illustrates bounding boxes B1 to B5 detected through the provisional clustering processing. The bounding boxes B1 to B5 respectively correspond to the measurement point clouds PC1 to PC5. As described above, the provisional detection unit 116 executes clustering processing by lowering the threshold value for the number of measurement points regarded as a point cloud so as to suppress the detection omission of the moving object. Therefore, the bounding box B5 corresponding to the measurement point cloud PC5 that includes only a few measurement points (two points in the drawing) is also detected. In addition, since the speed information is taken into account in classification of measurement points in the clustering processing performed on the XYV data, the measurement point clouds PC2 and PC3 corresponding to the pedestrians HM32 and HM33 who are moving at different absolute moving speeds are recognized as different measurement point clouds, even when the measurement point clouds PC2 and PC3 are close to each other, rather than being recognized as a single measurement point cloud. As a result, as illustrated in FIG. 3B, the bounding boxes B2 and B3 corresponding to the measurement point clouds PC2 and PC3 are respectively detected.

The superimposition unit 117 estimates a movement amount of the moving object detected by the provisional detection unit 116 from a past frame (for example, a previous frame) to a current frame. The superimposition unit 117 superimposes the XYV data of the current frame and the XYV data of the past frame on the basis of the estimated movement amount. The XYV data generated by this superimposition is referred to as superimposed speed-added data or superimposed XYV data.

Here, generation of the superimposed XYV data will be described. First, the superimposition unit 117 estimates the movement vector (absolute moving speed and moving direction) of the moving object detected by the provisional detection unit 116 in accordance with the following Formula (vi). Hereinafter, the moving object detected by the provisional detection unit 116 may be referred to as a provisional detection object.

$$L ( V , f ( A , {V}_{self} ) ) = \vert V + A \cdot {{V}_{self}}^{T} - A \cdot {{V}_{Model}}^{T} \vert \qquad Formula ( vi )$$

In Formula (vi), Vmodel is a movement vector of measurement points corresponding to the provisional detection object, and is represented by (vxi, vyi, vzi) (i=1, 2, . . . , m) when the number of measurement points constituting the provisional detection object is m. Vself is a movement vector of the subject vehicle estimated by the estimation unit 112 using Formula (iii). A is a matrix of unit vectors ei of n measurement points corresponding to the road surface, which are used for estimation of Vself. V represents a 1×n matrix indicating speed components (relative moving speeds) of the n measurement points corresponding to the road surface, which are used for estimation of Vself.

The superimposition unit 117 stores, in the memory unit 12, the calculated movement vector Vmodel in association with the frame ID of the current frame, together with information (identifier) that enables identification of the corresponding provisional detection object. In a case where a plurality of moving objects are detected by the provisional detection unit 116, the superimposition unit 117 calculates each of the movement vectors respectively corresponding to the moving objects (provisional detection objects). Each calculated movement vector is stored in the memory unit 12 together with information (identifier) that enables identification of the corresponding provisional detection object.

Next, the superimposition unit 117 reads, from the memory unit 12, the movement vector of the provisional detection object, which has been stored in association with the frame ID of the past frame. The superimposition unit 117 calculates a movement amount from the past frame to the current frame of the provisional detection object by multiplying a speed component of the movement vector of the provisional detection object, which has been read from the memory unit 12, by an elapsed time from the past frame to the current frame. The superimposition unit 117 executes offset processing of offsetting (translating) the measurement point cloud corresponding to the provisional detection object, included in the XYV data of the past frame, on the basis of the calculated movement amount and the direction indicated by the movement vector.

In a case where the XYV data of the past frame includes the measurement point clouds corresponding to a plurality of provisional detection objects, the offset processing is executed for each of the measurement point clouds corresponding to the respective provisional detection objects. The superimposition unit 117 superimposes the above measurement point cloud subjected to the offset processing onto the XYV data of the current frame to generate superimposed XYV data.

The superimposition unit 117 may also superimpose the measurement point clouds of a plurality of past frames onto the XYV data of the current frame to generate superimposed XYV data. For example, in a case where a frame n (n: frame number) is used as the current frame, superimposed XYV data may be generated by superimposing the measurement point cloud of the provisional detection object included in the XYV data of each of frames n-1, n-2, and n-3, onto the XYV data of the frame n. In this case, the superimposition unit 117 calculates movement vectors mvn-1, mvn-2, and mvn-3 of the provisional detection object corresponding to the frames n-1, n-2, and n-3, respectively, by using the above Formula (vi). The superimposition unit 117 then calculates movement amounts MAn-1, MAn-2, and MAn-3 of the provisional detection object between the frame n and the frames n-1, n-2, and n-3, respectively, by multiplying speed components of the calculated movement vectors mvn-1, mvn-2, and mvn-3 by movement times T, T×2, and T×3, respectively.

The superimposition unit 117 executes the offset processing on each of the measurement point clouds of the provisional detection objects corresponding to the frames n-1, n-2, and n-3 on the basis of the directions of the movement vectors mvn-1, mvn-2, and mvn-3 and the movement amounts MAn-1, MAn-2, and MAn-3. The superimposition unit 117 then superimposes each of the measurement point clouds of the provisional detection objects of the frames n-1, n-2, and n-3, which have been subjected to the offset processing, onto the XYV data of the frame n to generate superimposed XYV data.

In a case where a subject vehicle 101 is traveling, the superimposition unit 117 further executes offset-rotation processing of offsetting and rotating the measurement point clouds of the provisional detection objects included in the XYV data of the past frame on the basis of an azimuth angle difference between frames of the subject vehicle 101 and the movement vector. The movement vector of the subject vehicle 101 represents a moving direction of the representative point (such as a centroid) of the subject vehicle 101 between the frames and a moving speed in such a moving direction. The azimuth angle difference of the subject vehicle 101 is an angle difference of the azimuth in the current frame with respect to the azimuth (traveling direction) of the subject vehicle 101 in the past frame. The azimuth angle difference and the movement vector of the subject vehicle 101 can be estimated by executing predetermined scan matching processing to superimpose stationary point cloud data of the past frame onto stationary point cloud data of the current frame.

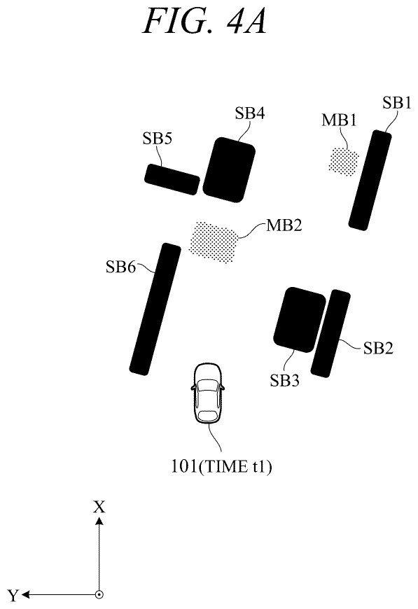

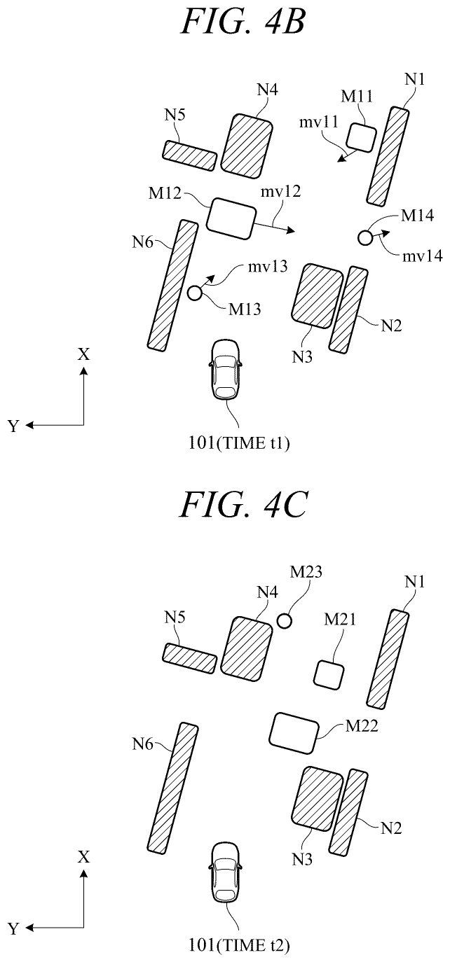

FIG. 4A is a diagram illustrating an example of a three-dimensional space around the subject vehicle. In FIG. 4A, an up-down direction (X-axis direction) represents the moving direction (traveling direction) of the subject vehicle 101. A lateral direction (left-right direction in FIG. 4A) and a height direction (direction from the depth side to the near side in FIG. 4A) with respect to the X-axis direction respectively represent Y-axis direction and Z-axis direction.

FIG. 4A illustrates the subject vehicle 101 and objects existing around the subject vehicle 101 at time point t1. Objects SB1 to SB6 are stationary objects, and objects MB1 and MB2 are moving objects. The stationary objects SB1 to SB6 include a road surface of a road on which the subject vehicle 101 is traveling, a structure such as a wall or a median strip installed on the sides of the road, and other vehicles parked on a road shoulder. The moving objects include, for example, other vehicles and pedestrians. For simplification of description, it is assumed that the subject vehicle 101 is stopped.

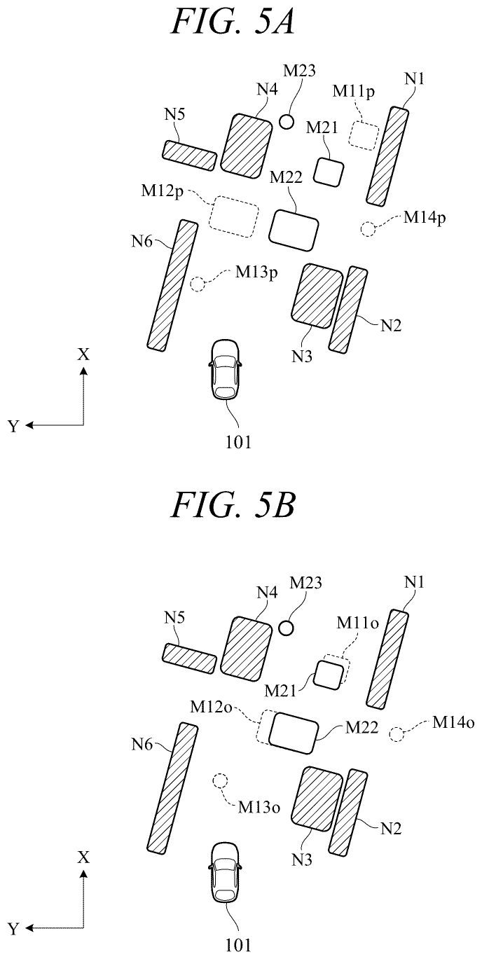

FIGS. 4B and 4C are diagrams illustrating examples of XYV data that is generated by the generation unit 115 and corresponds to the three-dimensional space of FIG. 4A. In practice, measurement point clouds N1 to N6 corresponding to the stationary objects SB1 to SB6 are not included in the XYV data generated by the generation unit 115, but in FIGS. 4B and 4C, the measurement points are illustrated for ease of viewing the drawings. The same applies to FIGS. 5A, 5B, 6, and 7, which will be described later.

FIG. 4B illustrates XYV data of the past frame (frame at time point t1). FIG. 4C illustrates XYV data of the current frame (current (time point t2) frame after a frame time T has elapsed from time point t1). In FIGS. 4B and 4C, the up-down direction (X-axis direction) represents the moving direction (traveling direction) of the subject vehicle 101. The lateral direction (left-right direction in the drawings) with respect to the X-axis direction represents the Y-axis direction.

In FIGS. 4B and 4C, regions N1 to N6 schematically represent the measurement point clouds corresponding to the stationary objects SB1 to SB6, more specifically, the positions and the sizes of the measurement point clouds. Regions M11 and M12 in FIG. 4B schematically represent the measurement point clouds corresponding to the moving objects MB1 and MB2, more specifically, the positions and the sizes of the measurement point clouds. Regions M13 and M14 in FIG. 4B represent measurement points or measurement point clouds that do not correspond to any moving object of the moving objects MB1 and MB2 and indicate noise. Arrows mv11 to mv14 in FIG. 4B schematically illustrate movement vectors Vmodel of measurement point clouds M1 to M4 estimated by the above Formula (vi).

Regions M21 and M22 in FIG. 4C schematically represent the measurement point clouds corresponding to the moving objects MB1 and MB2, more specifically, the positions and the sizes of the measurement point clouds. A region M23 in FIG. 4C represents a measurement point or a measurement point cloud that does not correspond to any moving object of the moving objects MB1 and MB2 and indicates noise.

FIGS. 5A and 5B are diagrams illustrating examples of the measurement point cloud of the past frame superimposed on the XYV data of the current frame. FIG. 5A illustrates an example of the XYV data of the current frame in which the measurement point clouds M11 to M14 of the moving objects included in the XYV data of the past frame are superimposed without being subjected to offset processing. FIG. 5B illustrates an example of the XYV data of the current frame, that is, the superimposed XYV data generated by the superimposition unit 117, in which the measurement point clouds M11 to M14 of the moving objects included in the XYV data of the past frame are superimposed after being subjected to offset processing.

In FIG. 5A, regions M11p to M14p indicated by broken lines schematically represent the measurement point clouds M11 to M14 of the past frame superimposed on the current frame. In FIG. 5B, regions M11o to M14o indicated by broken lines schematically represent the measurement point clouds M11 to M14 of the past frame superimposed on the current frame. The measurement point clouds M11o to M14o in FIG. 5B are respectively offset, with respect to the measurement point clouds M11p to M14p in FIG. 5A, in directions of movement vectors mv11 to mv14 by movement amounts obtained by multiplying speed components of the movement vectors mv11 to mv14 by a frame time T.

Since each measurement point of the XYV data of the past frame has speed information indicating a relative moving speed, a moving speed and a moving direction of each measurement point can be estimated on the basis of the speed information. Therefore, the superimposition unit 117 may offset each measurement point of the XYV data of the previous frame on the basis of the speed information of each measurement point. Then, the superimposition unit 117 may superimpose each offset measurement point onto the XYV data of the current frame to generate superimposed XYV data.

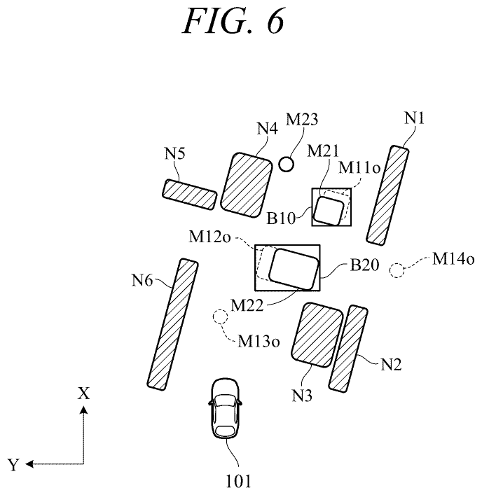

FIG. 6 is a diagram for describing detection of a moving object by the detection unit 118. The detection unit 118 executes clustering processing on the superimposed XYV data (FIG. 5B) generated by the superimposition unit 117 to detect moving objects around the subject vehicle.

In the superimposed XYV data in FIG. 5B, since the measurement point cloud M11o overlaps with the measurement point cloud M21, the clustering processing recognizes the measurement point cloud M11o and the measurement point cloud M21 as one measurement point cloud. As a result, even in a case where the number of measurement points in either the measurement point cloud M11o or the measurement point cloud M21 is less than the threshold value Th1, when a total number of measurement points is equal to or greater than the threshold value Th1, a bounding box B10 surrounding both measurement point clouds is detected, as illustrated in FIG. 6. Similarly, a bounding box B20 surrounding the measurement point cloud M120 and the measurement point cloud M22 is detected.

The detection unit 118 detects positions and sizes of moving objects (objects MB1 and MB2 in FIG. 4A) in a three-dimensional space (XYZ space) on the basis of positions and sizes of the detected bounding boxes B10 and B20.

As described above, by offsetting the measurement point clouds of moving objects that have been provisionally detected in the previous frame and superimposing the measurement point clouds onto the XYV data of the current frame (FIG. 5B), the number of measurement points corresponding to the moving objects can be increased. As a result, even a moving object such as a distant moving object or a small-sized moving object, for which a sufficient number of corresponding measurement points do not exist within a single frame, can be detected at an early stage. In addition, as in the measurement point clouds M13o and M14o in FIG. 6, among the measurement point clouds of the past frame superimposed on the current frame, the measurement point cloud that is not included in any bounding box can be determined as noise.

The vector calculation unit 119 calculates the movement vector of the moving object detected by the detection unit 118. First, the vector calculation unit 119 executes determination processing for identifying the same object between frames (between the past frame and the current frame) for the moving object detected by the detection unit 118. In this determination processing, it is determined that the measurement point cloud of the current frame (hereinafter referred to as a current measurement point cloud) and the measurement point cloud of the past frame (hereinafter referred to as a superimposed measurement point cloud) that has been superimposed on the current frame, which are included in the bounding box detected by the detection unit 118, correspond to the same moving object. In the example of FIG. 6, it is determined that the current measurement point cloud M21 and the superimposed measurement point cloud M110 that are included in the bounding box B10 correspond to the same moving object. In addition, it is determined that the current measurement point cloud M22 and the superimposed measurement point cloud M120 that are included in the bounding box B20 correspond to the same moving object.

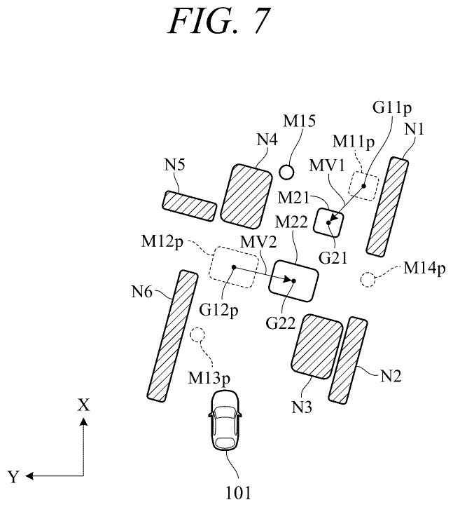

The vector calculation unit 119 calculates the movement vector of the moving object detected by the detection unit 118, on the basis of a result of the determination processing. FIG. 7 is a diagram for describing calculation of the movement vector of the moving object by the vector calculation unit 119.

First, as illustrated in FIG. 7, the vector calculation unit 119 superimposes the XYV data of the past frame onto the XYV data of the current frame. In FIG. 7, the XYV data of the past frame (frame at time point t1) is indicated by broken lines, and the XYV data of the current frame (frame at time point t2) is indicated by solid lines. In a case where the subject vehicle 101 is traveling, the vector calculation unit 119 executes offset-rotation processing on the XYV data of the past frame prior to the superimposition, on the basis of the movement vector and the azimuth angle difference of the subject vehicle 101.

The measurement point clouds M11p to M14p in FIG. 7 are the measurement point clouds M11 to M14 of the past frame superimposed on the current frame. Representative points G11p, G12p, G21, and G22 represent centroids of the measurement point clouds M11p, M12p, M21, and M22. The representative points G11p, G12p, G21, and G22 may be points other than the centroids.

The vector calculation unit 119 calculates a movement vector MV1 on the basis of a positional relationship between the representative point G21 of the measurement point cloud M21 and the representative point G11p of the measurement point cloud M11p, which is determined to correspond to the same moving object as the measurement point cloud M21. The movement vector MV1 indicates the moving speed and the moving direction of the moving object corresponding to the measurement point cloud M11p and the measurement point cloud M21 from the past frame to the current frame.

Similarly, the vector calculation unit 119 calculates a movement vector MV2 of the moving object corresponding to the measurement point cloud M12p and the measurement point cloud M22 on the basis of a positional relationship between the representative points G12p and G22. The vector calculation unit 119 stores the calculated movement vectors MV1 and MV2 in the memory unit 12 together with the information (identifier) that enables identification of the corresponding moving objects.

When the movement vectors (movement vectors MV1 and MV2 in FIG. 7) corresponding to the moving objects (objects MB1 and MB2 in FIG. 4A) detected by the detection unit 118 are stored in the memory unit 12, the tracking unit 120 sets the corresponding moving objects as tracking targets. The tracking unit 120 obtains a movement path of each moving object set as the tracking target (hereinafter referred to as a tracking target object) between frames (from the past frame to the current frame) on the basis of the movement vector of the tracking target object. The tracking unit 120 tracks the movement path of the tracking target object by accumulating the movement paths obtained for each frame while the tracking target object is detected by the detection unit 118.

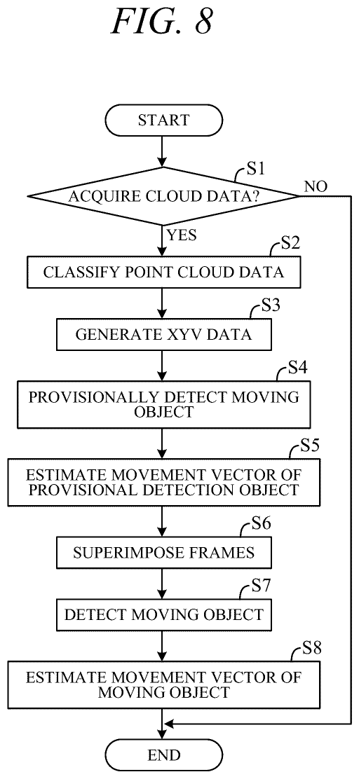

FIG. 8 is a flowchart illustrating an example of processing executed by a processing unit 11 of a controller 10 in FIG. 1 in accordance with a predetermined program. The processing illustrated in this flowchart is repeated at predetermined intervals, while a vehicle control apparatus 100 is activated. More specifically, the processing is repeatedly executed at intervals corresponding to the frame rate of the LiDAR 5.

First, in step S1, an external environment situation around the subject vehicle is detected. Specifically, an emission command is transmitted to the LiDAR 5, and point cloud data (detection data) including position information and speed information of measurement points from which reflected waves of electromagnetic waves emitted from the LiDAR 5 in response to the emission command are obtained are acquired. In step S2, the point cloud data acquired in step S1 is classified into moving point cloud data and stationary point cloud data.

Next, processing of steps S3 to S8 is executed on the moving point cloud data. Note that predetermined processing is also executed on the stationary point cloud data by the controller 10, but the description is omitted.

In step S3, speed-added data (XYV data) is generated by adding the absolute moving speed to each piece of position information of each measurement point included in the moving point cloud data, and in step S4, provisional clustering processing is executed on the XYV data generated in step S3. As a result, moving objects around the subject vehicle 101 are provisionally detected. The provisional detection result of the moving object is stored in the memory unit 12 in association with the frame ID of the current frame together with the generated XYV data. The provisional detection result includes information that enables identification of the measurement point cloud corresponding to the provisionally detected moving object.

In step S5, the movement vector of the moving object, which is provisionally detected in step S4, is estimated using the above Formula (vi). The estimated movement vector is stored in the memory unit 12 as a part of the provisional detection result together with information (identifier) that enables identification of the corresponding moving object.

In step S6, the measurement point cloud corresponding to the moving object provisionally detected last time is offset and superimposed onto the XYV data (XYV data of the current frame) generated in step S3, on the basis of the provisional detection result of the previous frame, which is stored in the memory unit 12. More specifically, the measurement point cloud corresponding to the moving object provisionally detected last time is acquired from the XYV data of the previous frame on the basis of the provisional detection result, and the acquired measurement point cloud is offset on the basis of the movement vector of the corresponding moving object. The offset measurement point cloud is then superimposed onto the XYV data of the current frame. As a result, superimposed XYV data is generated.

In step S7, clustering processing is executed on the superimposed XYV data generated in step S6. The position and size of the bounding box detected through this clustering processing are detected as the position and size of the moving object around the subject vehicle.

Finally, in step S8, the movement vector of the moving object detected in step S7 is estimated (calculated). More specifically, the movement vector is calculated on the basis of the position of the measurement point cloud of the current frame (current measurement point cloud) included in the bounding box detected in step S7, and the position in the previous frame of the measurement point cloud of the previous frame (superimposed measurement point cloud) included in the bounding box and superimposed on the current frame.

As described above, since each measurement point of the XYV data has speed information indicating a relative moving speed, each measurement point may be individually offset on the basis of the speed information. That is, without executing the processing of steps S4 and S5, in step S6, each measurement point of the XYV data of the previous frame may be offset on the basis of the speed information of each measurement point. The offset measurement point may then be superimposed onto the XYV data generated in step S3 to generate superimposed XYV data.

According to the embodiment described above, the following effects are obtained.
(1) The object tracking apparatus 50 includes the LiDAR 5 that acquires point cloud data including, for measurement points on a surface of an object included in a three-dimensional space, three-dimensional position information and speed information indicating a relative moving speed, on a frame-by-frame basis, that is, for each point cloud frame including the point cloud data at the same time point, by emitting electromagnetic waves into the three-dimensional space and receiving reflected waves; the calculation unit 113 that calculates an absolute moving speed of each of the plurality of measurement points corresponding to the point cloud data on the basis of the speed information; the classification unit 114 that classifies, when the point cloud data is acquired by the LiDAR 5, the point cloud data into moving point cloud data, in which an absolute value of the absolute moving speed calculated by the calculation unit 113 is equal to or greater than a predetermined speed, and stationary point cloud data other than the moving point cloud data; the memory unit 12 that stores the moving point cloud data classified by the classification unit 114; the processing unit that performs object tracking processing of detecting a moving object that moves in the three-dimensional space; the vector calculation unit 119 that calculates a movement vector of the moving object detected by the processing unit; and the tracking unit 120 as a path acquisition unit that obtains a movement path of the moving object on the basis of the movement vector calculated by the vector calculation unit 119. The processing unit executes offset processing of offsetting the position of each measurement point in the moving point cloud data included in the past point cloud frames stored in the memory unit 12, on the basis of a moving speed and a moving direction of each measurement point estimated on the basis of the speed information of each measurement point. When the moving point cloud data is classified by the classification unit from the point cloud data newly acquired by the LiDAR 5, the processing unit executes superimposition processing of superimposing the offset moving point cloud data of the past frames onto the moving point cloud data, and executes processing of detecting the moving object on the basis of the moving point cloud data after the superimposition processing. The vector calculation unit 119 calculates the movement vector of the moving object on the basis of the position of the measurement point cloud corresponding to the moving object in the past point cloud frame and the new point cloud frame.

More specifically, the processing unit executes clustering processing on the moving point cloud data after the superimposition processing, and detects the position and size of the cluster (measurement point cloud included in the bounding box) detected through the clustering processing as the position and size of the moving object, and the vector calculation unit 119 calculates the movement vector of the moving object on the basis of the position, which is before the offset processing, of the measurement point cloud corresponding to the past point cloud frame included in the cluster and the position of the measurement point cloud corresponding to a new point cloud frame included in the cluster.

With such a configuration, a distant object and a small-sized object can be detected at an early stage, and the moving object can be accurately tracked. In addition, the offset processing described above allows a moving object having a large movement amount between frames to be accurately detected. As a result, even in a case where the position of the moving object as a tracking target changes significantly between frames, tracking can be continuously performed without losing the moving object.
(2) When the moving point cloud data is classified by the classification unit 114 from the point cloud data newly acquired by the LiDAR 5, the processing unit executes provisional clustering processing as first clustering processing in which a minimum number of points in a cluster as a detection target is set to a first predetermined number, on the moving point cloud data. In addition, in the offset processing, the processing unit offsets the position of each measurement point belonging to the cluster included in the moving point cloud data of the past frame on the basis of the moving speed and the moving direction of the cluster estimated on the basis of the speed information of each measurement point. In addition, in the superimposition processing, the processing unit superimposes data of each measurement point belonging to the cluster in the moving point cloud data of the past frame that has been subjected to the offset processing, onto the newly acquired moving point cloud data. In addition, the processing unit executes clustering processing as second clustering processing in which a minimum number of points is set to a second predetermined number greater than the first predetermined number, on the moving point cloud data after the superimposition processing. Furthermore, the processing unit detects the position and size of the moving object in the three-dimensional space on the basis of the position and size of the cluster detected through the second clustering processing. As a result, a distant object and a small-sized object can be detected at an early stage with high accuracy.
(3) The LiDAR 5 is mounted on a moving body. The above speed information is first speed information, and the object tracking apparatus 50 further includes the estimation unit 112 serving as a speed acquisition unit configured to acquire second speed information indicating an absolute moving speed of the moving body. The calculation unit 113 calculates the absolute moving speed of each of the plurality of measurement points corresponding to the point cloud data on the basis of the first speed information and the second speed information. The classification unit 114 classifies the point cloud data such that the measurement point of which the absolute value of the absolute moving speed calculated by the calculation unit 113 is equal to or greater than the predetermined speed is classified as the moving point cloud data. As a result, even in a case where the LiDAR is mounted on a moving body, a distant object and a small-sized object can be detected at an early stage.

The above-described embodiment can be modified in various manners. Hereinafter, modified examples will be described. In the above-described embodiments, the LiDAR 5 serving as the detection unit is mounted on a vehicle, and acquires point cloud data including three-dimensional position information at measurement points on a surface of an object included in a three-dimensional space around the vehicle and speed information indicating a relative moving speed, by emitting electromagnetic waves into the three-dimensional space and receiving reflected waves. However, the detection unit may be other than the LiDAR. Specifically, the detection unit may be a 4D imaging radar configured to acquire four-dimensional information (point cloud data) including the distance, azimuth angle, elevation angle, and relative moving speed of the measurement point on the surface of the object included in the three-dimensional space by emitting millimeter radio waves and receiving reflected waves. In addition, the moving body on which the detection unit is mounted may be other than a vehicle, for example, a self-propelled robot.

In the above-described embodiments, the object tracking apparatus constituting a part of the vehicle control apparatus 100 has been described as an example. However, the object tracking apparatus and the detection unit included in the object tracking apparatus may be provided outside the vehicle and may be of a stationary type.

In addition, in the above-described embodiment, the superimposition unit 117 and the detection unit 118 are configured, as the processing unit, to execute the offset processing and then execute the superimposition processing. However, the processing unit may execute the superimposition processing and then execute the offset processing.

In the above-described embodiment, the generation unit 115 converts the moving point cloud data obtained by the classification unit 114 into two-dimensional data, and generates three-dimensional speed-added data (XYV data) by adding the absolute moving speed to the moving point cloud data converted into two-dimensional data, and the provisional detection unit 116 and the detection unit 118 execute clustering processing on the XYV data to detect the moving object around the subject vehicle. However, in a case where accuracy of a cluster size in the three-dimensional space (XYZ space) is required, such clustering processing may be executed on the XYZ space. Specifically, the generation unit may generate four-dimensional speed-added data (hereinafter referred to as XYZV data) by adding the absolute moving speed to the moving point cloud data obtained by the classification unit 114. In this case, the provisional detection unit 116 and the detection unit 118 execute the clustering processing on the XYZV data.

In the above-described embodiment, the estimation unit 112 serving as the speed acquisition unit selects a measurement point Pi as a representative measurement point from among remaining measurement points excluding measurement points corresponding to a three-dimensional object from a plurality of measurement points, estimates an absolute moving speed of the subject vehicle on the basis of position information and speed information of the representative measurement point extracted from point cloud data acquired by the data acquisition unit 111, and acquires the estimation result as second speed information. However, the speed acquisition unit may alternatively acquire a measurement result of the absolute moving speed of the subject vehicle, which is obtained by a measuring instrument included in the internal sensor group 3, as the second speed information. In this case, the object tracking apparatus 50 includes, as the measuring instrument, at least a vehicle speed sensor among the internal sensor group 3. The speed acquisition unit may calculate and acquire the absolute moving speed of the subject vehicle on the basis of a current position of the subject vehicle measured by a position measurement unit 2. In this case, the object tracking apparatus 50 includes the position measurement unit 2.

In addition, in the above-described embodiment, the driving control unit 121 controls traveling of the subject vehicle so as to avoid a collision or contact with an object detected by the detection unit 118. However, the driving control unit 121 may, as an output unit, output information (such as image information) indicating the position and size of the object detected by the detection unit 118 as a detection result to a display device or the like (not illustrated). In addition, the driving control unit 121 may also, as a notification unit, predict a possibility of collision or contact with a moving object on the basis of the size, position, and moving speed of the moving object detected by the detection unit 118. Then, when the possibility of collision or contact with the moving object is equal to or greater than a predetermined level, an occupant of the subject vehicle may be notified of information (video information or audio information) for calling for attention about collision or contact with the moving object detected by the detection unit 118 via a display or a speaker (both not illustrated) included in the vehicle control apparatus 100.

Furthermore, in the above-described embodiment, the object tracking apparatus 50 is applied to the self-driving vehicle, but the object tracking apparatus 50 is also applicable to any vehicle other than the self-driving vehicle. For example, the object tracking apparatus 50 is also applicable to a manual driving vehicle including advanced driver-assistance systems (ADAS).

The above embodiment can be combined as desired with one or more of the above modifications. The modifications can also be combined with one another.

According to the present invention, a distant moving object and a small-sized moving object can be accurately tracked.

Above, while the present invention has been described with reference to the preferred embodiments thereof, it will be understood, by those skilled in the art, that various changes and modifications may be made thereto without departing from the scope of the appended claims.

What is claimed is:

1. An object tracking apparatus comprising:
a detector configured to acquire point cloud data including, for measurement points on a surface of an object included in a three-dimensional space, three-dimensional position information and speed information indicating a relative moving speed, by emitting electromagnetic waves into the three-dimensional space and receiving reflected waves, for each point cloud frame including the point cloud data at a same time point;
an actuator for vehicle travel;
a microprocessor; and
a memory connected to the microprocessor, wherein
the microprocessor is configured to perform:
calculating an absolute moving speed of each of a plurality of the measurement points corresponding to the point cloud data based on the speed information;
classifying, when the point cloud data is acquired by the detector, the point cloud data into moving point cloud data in which an absolute value of the absolute moving speed is equal to or greater than a predetermined speed, and stationary point cloud data other than the moving point cloud data;
storing the moving point cloud data classified in the classifying in the memory;
executing object tracking processing of detecting a moving object moving in the three-dimensional space,
calculating a movement vector of the moving object, and
obtaining a movement path of the moving object based on the movement vector, and wherein,
in the object tracking processing, the microprocessor is configured to perform:
executing offset processing of offsetting a position of each measurement point corresponding to past point cloud frames stored in the memory, based on a moving speed and a moving direction of each measurement point estimated based on the speed information of the measurement point;
executing, when the moving point cloud data is classified from the point cloud data included in a new point cloud frame acquired by the detector, superimposition processing of superimposing the offset moving point cloud data of the past point cloud frames onto the moving point cloud data; and
detecting the moving object based on the moving point cloud data after the superimposition processing; and
the microprocessor is configured to perform:
the calculating of the movement vector including calculating the movement vector of the moving object based on a position of measurement point cloud corresponding to the moving object in the past point cloud frame and the new point cloud frame.

2. The object tracking apparatus according to claim 1, wherein
the microprocessor is configured to perform:
in the object tracking processing, executing clustering processing on the moving point cloud data after the superimposition processing, and detecting a position and size of a cluster detected through the clustering processing as a position and size of the moving object, and wherein
the microprocessor is configured to perform:
the calculating of the movement vector including calculating the movement vector of the moving object based on the position, which is before the offset processing, of measurement point cloud corresponding to the past point cloud frame included in the cluster and the position of measurement point cloud corresponding to the new point cloud frame included in the cluster.

3. The object tracking apparatus according to claim 1, wherein
the microprocessor is configured to perform:
in the object tracking processing, executing, when the moving point cloud data is classified from point cloud data included in the new point cloud frame, first clustering processing in which a minimum number of points in a cluster serving as a detection target is set to a first predetermined number, on the moving point cloud data;
in the offset processing, offsetting a position of each measurement point belonging to the cluster included in the moving point cloud data of the past point cloud frame, based on a moving speed and a moving direction of the cluster estimated based on the speed information of each measurement point;
in the superimposition processing, superimposing data of each measurement point belonging to the cluster in the moving point cloud data of the past point cloud frame subjected to the offset processing, onto the moving point cloud data classified from the point cloud data included in the new point cloud frame;
executing, on the moving point cloud data after the superimposition processing, second clustering processing in which a minimum number of points is set to a second predetermined number greater than the first predetermined number; and
detecting a position and a size of the moving object in the three-dimensional space based on a position and a size of the cluster detected through the second clustering processing.

4. The object tracking apparatus according to claim 1, wherein
the detector is mounted on a moving body.

5. The object tracking apparatus according to claim 4, wherein
the speed information is first speed information, and
the microprocessor is configured to further perform:
acquiring second speed information indicating an absolute moving speed of the moving body;
in the calculating of the absolute moving speed, calculating the absolute moving speed of each of the plurality of the measurement points corresponding to the point cloud data based on the first speed information and the second speed information; and
in the classifying, classifying the point cloud data such that a measurement point of which an absolute value of the absolute moving speed of each of the plurality of the measurement points is equal to or greater than the predetermined speed is classified as the moving point cloud data.

6. The object tracking apparatus according to claim 1, wherein
the detector is a LiDAR or a radar.

7. A vehicle control apparatus comprising:
a detector configured to acquire point cloud data including, for measurement points on a surface of an object included in a three-dimensional space, three-dimensional position information and speed information indicating a relative moving speed, by emitting electromagnetic waves into the three-dimensional space and receiving reflected waves, for each point cloud frame including the point cloud data at a same time point;
an actuator for vehicle travel;
a microprocessor; and
a memory connected to the microprocessor, wherein
the microprocessor is configured to perform:
calculating an absolute moving speed of each of a plurality of the measurement points based on the speed information;
classifying, when the point cloud data is acquired by the detector, the point cloud data into moving point cloud data in which an absolute value of the absolute moving speed is equal to or greater than a predetermined speed, and stationary point cloud data other than the moving point cloud data;
storing the moving point cloud data classified in the classifying in the memory;
executing object tracking processing of detecting a moving object moving in the three-dimensional space;
calculating a movement vector of the moving object,
obtaining a movement path of the moving object based on the movement vector, generating a target trajectory based on a detection result of the moving object; and
controlling the actuator such that a subject vehicle travels along the target trajectory, and wherein
in the object tracking processing, the microprocessor is configured to perform:
executing offset processing of offsetting a position of each measurement point corresponding to past point cloud frames stored in the memory, based on a moving speed and a moving direction of each measurement point estimated based on the speed information;
executing, when the moving point cloud data is classified from the point cloud data included in a new point cloud frame acquired by the detector, superimposition processing of superimposing the offset moving point cloud data of the past point cloud frames onto the moving point cloud data;
detecting the moving object based on the moving point cloud data after the superimposition processing; and
the microprocessor is configured to perform:
the calculating of the movement vector including calculating the movement vector of the moving object based on a position of measurement point cloud corresponding to the moving object in the past point cloud frame and the new point cloud frame.
